(19) United States
(12) Patent Application Publication
(10) Pub. No.: US 2014/0089472 A1
(43) Pub. Date: Mar. 27, 2014

(54) SYSTEM AND METHOD FOR SEMANTIC KNOWLEDGE CAPTURE

(71) Applicant: David Tessler, Toronto (CA)

(72) Inventor: David Tessler, Toronto (CA)

(21) Appl. No.: 14/123,276

(22) PCT Filed: Jun. 4, 2012
(86) PCT No.: PCT/CA2012/000540

§ 371 Date: Dec. 2, 2013

Related U.S. Application Data
(60) Provisional application No. 61/493,193, filed on Jun. 3, 2011.

(51) Int. Cl. H04L 29/08

(52) U.S. Cl. CPC H04L 67/22; H04L 67/02
USPC 709/219; 709/224

(57) ABSTRACT

The present disclosure relates to a system and method for capturing knowledge and interests of a user by conducting semantic knowledge capture, utilizing a real-time, or near real-time, viewport analysis. In an embodiment, the method comprises initializing a semantic knowledge capture session for the user; identifying the location of one or more objects in a loaded page being viewed by the user; determining whether the one or more objects are viewable through a view-port controllable by the user; and in dependence upon user events, tracking the occurrences of the one or more objects being viewable through the viewpoint in a tracking array, thereby to analyze the user's knowledge and interests in the one or more objects.

### FIELD OF THE INVENTION

The present disclosure relates generally to a system and method for determining the interests and intent of an Internet user.

### BACKGROUND

Web analytics tools attempt to determine an individual user's preferences by collecting and analyzing statistics about a user's web browsing activities. Prior art approaches to collecting and analysing a user's browsing activities have focussed generally on analyzing web pages and their contents. While this type of analysis may generate a great deal of data, it may still be difficult to determine what is of particular interest to the user.

A commonly used technique in Internet marketing is audience segmentation. This is a process of dividing people into more similar subgroups based upon defined criteria such as product usage, demographics, psychographics, communication behaviours and media use. Audience segmentation is used in online marketing so advertisers can target content and ads for products and services that satisfy targeted groups.

Prior art segmentation solutions use historical data and inference in order to try to determine a person's future intent. Internet marketers generally use Data Management Platforms (DMPs) to collect, import and aggregate huge volumes of data from disparate online, offline, and third party sources on one platform in order to look for clues for placing a particular user into a defined marketing segment (e.g. “Auto Intenders”, “Lifestyle”, “Sports Fan”, etc.). Generally speaking, this is accomplished based on the user's browsing habits, including pages visited, time spent on an Internet page, keywords searched on, supplied information (sign up forms, surveys, polls, etc.) and other sources.

The problem is that this data is almost all historical in nature (particularly in the case of third-party data such as other web site's logs, credit card purchases, and affiliate and demand marketing), and may be months old. Its efficacy may further be called into question as it cannot account for devices with more than one user (e.g. a shared computer in a kitchen).

DMP's and Audience Segment systems are good at telling you what an audience may do in the future, but they cannot tell you what the current intent of a visitor on the site now is doing.

Yet there is a demand from marketers to engage in Internet advertising based on current information.

What is needed is an improved system and method for addressing at least some of these limitations in the prior art.

### SUMMARY

The present disclosure relates to a system and method for capturing knowledge and interests of a user by conducting semantic knowledge capture, utilizing a real-time, or near real-time, viewport analysis.

In an embodiment, the method comprises initializing a semantic knowledge capture session for the user; identifying the location of one or more objects in a loaded page being viewed by the user; determining whether the one or more objects are viewable through a viewport controllable by user events; and in dependence upon the user events, tracking the occurrences of the one or more objects being viewable through the viewport in a tracking array, thereby to analyze the user's knowledge and interests in the one or more objects.

In one aspect, a computer-implemented method for determining the interest or intent of an Internet user is provided comprising:
(a) initializing a semantic knowledge capture session for the user, using one or more computer processors:
(b) conducting a browser viewport analysis to identify one or more interactions between the user and one or more tagged information objects in one or more Internet content items, where the tagged information objects are related to one or more topics; and
(c) analyzing the one or more interactions, using an analyzer, in order to measure the interest or intent of the user in relation to the one or more topics.

In another aspect, there is a further step of using a dashboard to establish the one or more topics, and a list of associated find words that are related to the one or more topics.

In a still further aspect, the method includes tagging the internet content using the find words, and using the viewport analysis to detect the interaction of the user with such find words in the internet content, and log such interactions in an array, and analyze the contents of the array so as to determine real time or near real time interest of the Internet user in the one or more topics.

In yet another aspect, the contents of the array enable determination of real time or near real time interest in relation to a single frame of Internet content.

In another aspect, the method includes the further step of linking the user with a particular segment based on the determination of real time or near real time interest.

In another aspect, the interactions consist of one or more of the following: viewing, selecting, clicking hyperlinks, or mouseing over.

In another aspect, a further step includes analyzing the interactions based on the frequency, recency, and volume of find words with which the interactions occurred.

In a still other step, data captured regarding interest or intent based on interactions of the user with a current internet frame.

In a still further aspect, the user is targeted content based on the user's membership in the segment.

In another aspect, the method includes using a campaign manager for designing one or more campaigns, including one or more interest or intent profiles that are configured to trigger actions in the campaign.

In another aspect, the method includes the step of calculating an interest or intent score for the user based on the interactions, and optionally further based on the one or more interest or intent profiles.

In yet another aspect, a computer system is provided for determining the interest or intent of one or more internet users comprising: (A) a web server configured to make accessible to users internet content such as web pages, the web server including or being inked to a plug-in, the plug-in being operable to tag internet content based on one or more topics, and associated find words; and (B) one or more client computers, each client computer including or being linked to a data collection component, the data collection component including a viewport utility, the viewport utility being operable to detect and log the interactions of the user with the find words,

In another aspect, the computer system further comprises a central server, the central server including or being linked to an analytics engine, wherein the data collection component logs the interactions and transfers information about the interactions to the central server, and the central server utilizes the analytics engine to extract semantic knowledge from the interactions on a real time or near real time basis.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a representative implementation of the computer system of the present invention;

FIG. 2a illustrates a representative interaction workflow involved in a particular implementation of the present invention, in this case involving client side tagging of content;

FIG. 2b illustrates a representative interaction workflow involved in a particular implementation of the present invention, in this case involving server side tagging of content;

FIG. 2c shows an example of a page lifecycle that enables the capture of semantic knowledge of users, in this case as implemented for a .NET™ infrastructure;

FIG. 3a shows an illustrative example of an initial state of a viewport in accordance with an embodiment;

FIG. 3b shows an illustrative example of the viewport of FIG. 1 after it has been scrolled;

FIG. 3c shows an illustrative example of tracking the position of objects relative to the viewport in accordance with an embodiment;

FIG. 4 shows a schematic diagram of an aspect of a system and method in accordance with an embodiment;

FIGS. 5A and 5B shows a schematic diagram of another aspect of the system and method in accordance with an embodiment;

FIGS. 6A and 6B shows a schematic diagram of another aspect of the system and method in accordance with an embodiment;

FIGS. 7A and 7B shows a schematic diagram of another aspect of the system and method in accordance with an embodiment; and

FIG. 8 illustrates a generic computer device and network that may provide a suitable operating environment for various embodiments of the system and method.

### DETAILED DESCRIPTION

As noted above, the present disclosure relates to a system and method for collecting knowledge and interests of a user by conducting semantic knowledge capture, utilizing a real-time, or near real-time, browser viewport analysis as described in further detail below.

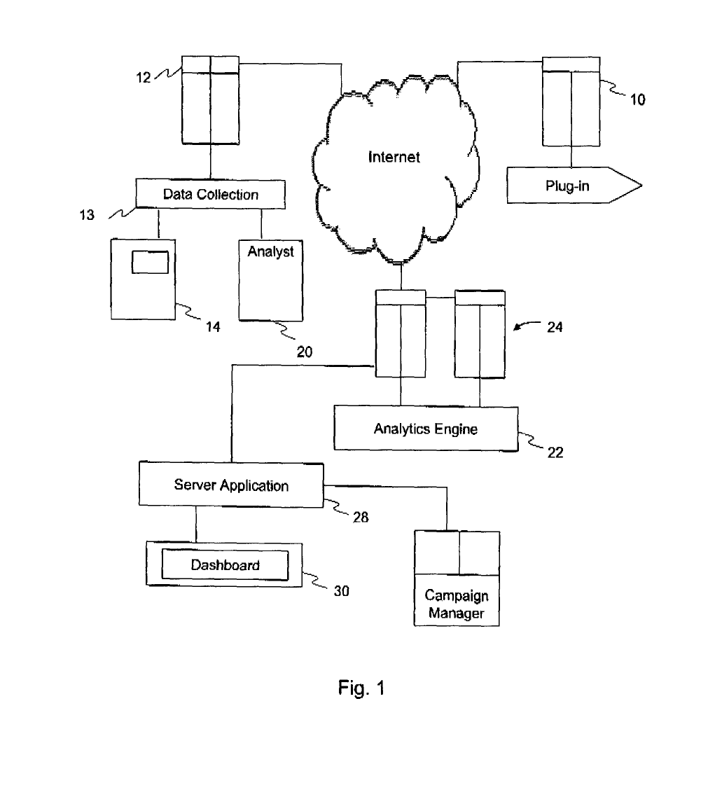

FIG. 1 illustrates a possible client-server implementation of the present invention. A web server (10) is connected to the internet. Through the internet the web server (10) connects to at least one client computer (12). The client computer (12) may be any manner of network connected device, including a desktop computer, tablet computer, or smart phone. The client computer (12) includes web browsing functionality (not shown). The web server (10) may connect to a variety of different client computers (12). Each client computer (12) is typically associated with a user who may be targeted by operation of the present invention.

The web server (10) is configured to make accessible to users internet content such as web pages, and these web pages may includes various text, graphical or image content. Loaded on the client computer (12) is the data Collection component (13) of the present invention.

A skilled reader will appreciate that the functions of the system of the present invention that includes (A) tagging of content, (B) logging of interactions between users and tagged content, (C) analysis of the interactions, and (D) targeting of users with content based on the analysis of the interactions, may be distributed across the various computer system components of the present invention. This disclosure describes different implementations of the computer system of the present invention for executing these functions. A skilled reader will understand that different implementations or computer architectures are possible.

In one implementation, the web server (10) implements the plug-in (14) of the present invention. The plug-in (14) may be configured to enable the operations described in this disclosure. In one aspect of the invention, a key function of the plug-in (14) is the tagging of content.

It should be understood that in another implementation of the present invention, a plug-in (14) may not be required if for example data is tagged by integrating tagging features for the present computer system in an application (for example as an add-in to a word processing computer program as described below).

The data collection component (13) in one aspect of the invention is operable to log the interactions of the user with the tagged content, for example in the manner described in this disclosure.

In one aspect of the invention, the data collection component (13) consists of or includes a viewport utility (14). The viewport utility (14) may be implemented in the manner detailed in this disclosure. In one implementation the data collection component (13) includes an event logger (15) for logging interactions of the user with tagged content that constitute “events” that are relevant to the knowledge capture functions of the system.

In another aspect of the invention, the computer system of the present invention implements one or more analytical operations, including for example semantic analytical operations that enable the extraction of knowledge, including semantic knowledge from the user's interactions with the content. These analytical operations may be implemented using an analyzer. A skilled reader will appreciate that the analyzer may be implemented by one or more components, using a number of different possible computer architecture implementations.

In one implementation of the invention, and as shown in FIG. 1, the data collection component (13) is configured to process certain client side analytical operations, as further detailed below. Therefore in FIG. 1, the data collection component (13) includes an analyzer (20).

The knowledge capture operations of the present invention benefit from centralization of certain data logging and analytical operations. The computer system includes an analytics engine (22). As shown in FIG. 1, the analytics engine (22) may be implemented to a central server (24). The central server (24), in one implementation is configured to connect to the various client computers, and store data collected by each data collection component into database (28) that is connected to the central server (24). The central server includes a server application (28) that is operable to enable a variety of server implemented operations of the present invention. The server application (28) may provide access to a dashboard (30) that enables clients of the operator of the central server (24) to access various services, as described in this disclosure. The server application (28) in one implementation includes or links to a campaign manager (32).

The dashboard (30) allows clients, through the campaign manager (32) to manage various campaigns, that may include targeting of users with content (such as ads), including as further detailed in this disclosure. In one aspect, the dashboard (30) allows clients (or their designates such as an ad agency) to set find words, and also configure various rules for segmenting users based on client objectives.

A skilled reader will appreciate that the dashboard (30) can provide access to the various available user targeting tools (including campaigns builders, campaign reporting tools, marketing spend optimization tools and so on). In accordance with the present invention, the use of these tools benefits from the extraction of semantic knowledge regarding targeted users on a timely basis. Such time knowledge capture regarding users was not possible prior to the present invention.

The campaign manager (32) enables clients to create and manage a variety of campaigns, for example optimization campaigns, content targeting campaign, poll campaigns, data collection campaigns, and others. For each campaign, marketers can use a drop & drag interface to create a series of rules which define the target audience for the marketing action/campaign they are configuring. In other words, generally speaking it is a requirement that these rules be met in order for the campaign action to be triggered (executed). The rules may be categorized using a schema configured to help marketers navigate the targeting function.

The technology of the present invention enables the discovery of a user's interests and intent. This is accomplished by analyzing what a user is reading, specifically by looking for specific keywords and phrases in content (such as text for example) that is relevant to a particular subject or topic. This subject or topic and associated keywords or phrases is referred to as a “segment” in the disclosure.

For example, a segment may be defined such as “Hockey”, and this segment will include a list of phrases that give meaning or depth to the topic (e.g. off-side, puck, Stanley Cup, NHL, rookie season, skate, skated, body check, etc. The present invention then uses a variety of mechanisms to measure the interaction of the user with these phrases. For example, the computer system tracks how many times a user has viewed these words across multiple sites, by detecting and logging such interactions as (mouseing over, selecting, clicking hyperlinks with those any of the words in it, etc . . . ). This information, in one implementation, is sent to the central server and is “scored” to represent how much the user is interested in “hockey”. Interest may be measured for example as a value between 0-1 (a percentage).

A viewer's membership within a segment is determined by counting the frequency, recency, and volume of keywords viewed from a segment within their browser.

Another important aspect of the invention, is that the architecture described enables the tagging of a significant number of words, and then use of these words to take a significant number of samples. The present invention makes it feasible to generate better quality data, which in turn supports deeper insights into interests and intent.

We can now compare the total keywords viewed and exposure time in segment and compare it to another. You compare recency of data; i.e. last week vs. this week. Or how someone's interest in a segment(s) changes over time (daily, weekly, monthly). You can see how sub-segments compare against each other or how they affect the overall score within a segment. E.g. Hockey and its words are all a sub-segment of “Sports”. You could compare someone relative interests in Hockey vs. Tennis. Or determine that someone is a rabid hockey fan but not a fan of any other sports.

Another significant fact is that this is all first party data. We are collecting the data in the viewer's own timeframe, which makes it possible to segment them within the very first page view—without them leaving the page. First party data comes directly from the viewer—what they read, what they did, how they did it. Third-party data is historical, out of date, and may have no bearing on what the person is doing right now. It also frequently needs to be purchased from other companies.

Another aspect of the technology of the present invention is that is enables the comparison of incoming data to existing data which allows us to test whether the current user of the device is the same person as before. This ability to track a user across multiple sites improves the quality of the data and obviates the needs for the various techniques that are normally used to try to track a user across several internet sessions or across multiple sites associated with multiple web servers.

A skilled reader will appreciate that the present invention enables the writing of a (first party) cookie in the user' browser which means the data can immediately be consumed by the site itself, or its other integrated services (e.g. their ad server, private ad exchange, sell-side platform, CRM system, demand email system, etc . . . ). A skilled reader will appreciate that this represents a significant innovation. Prior art solutions seek more and more data that records a person's previous actions (i.e. page URL and topic, site theme, click actions), effectively supplementing the data set used for targeting with past information. However, this past information is often of limited relevance, because interests and intent changes quickly over time and thus past information may not be relevant and in fact may distort the analysis and provide an inaccurate picture of current interests or intent. The present invention provides access to more relevant, and more extensive data sets. The analysis of these data sets permits far greater insight into interests or intent.

Viewport

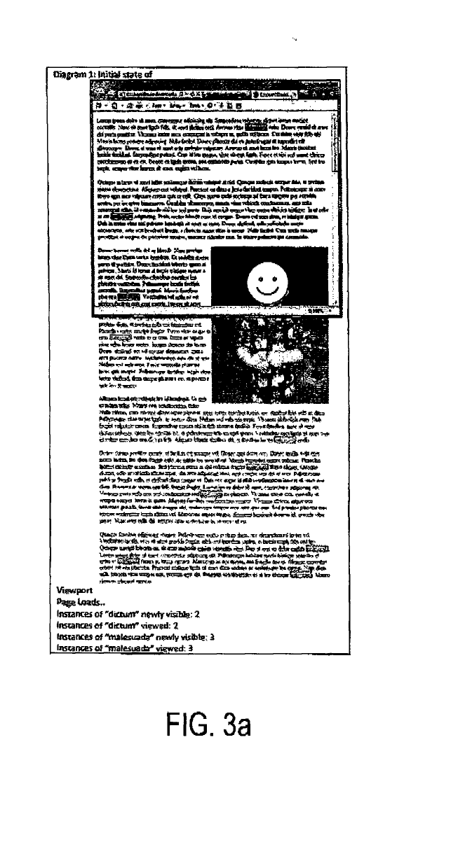

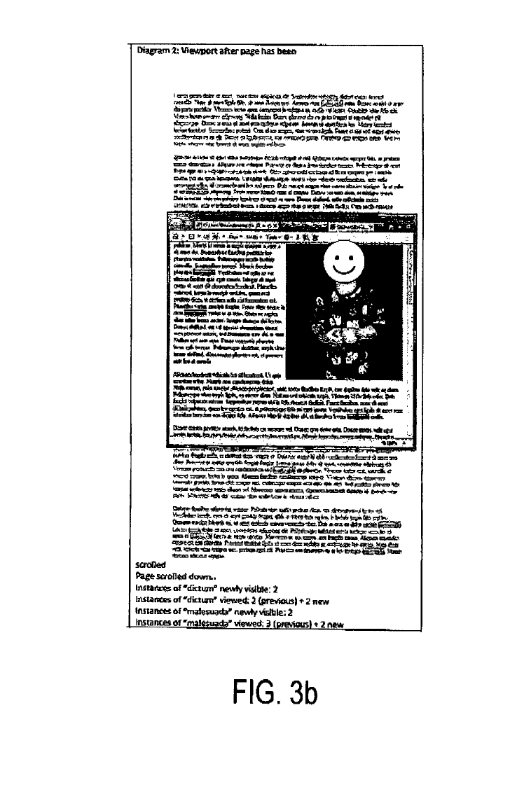

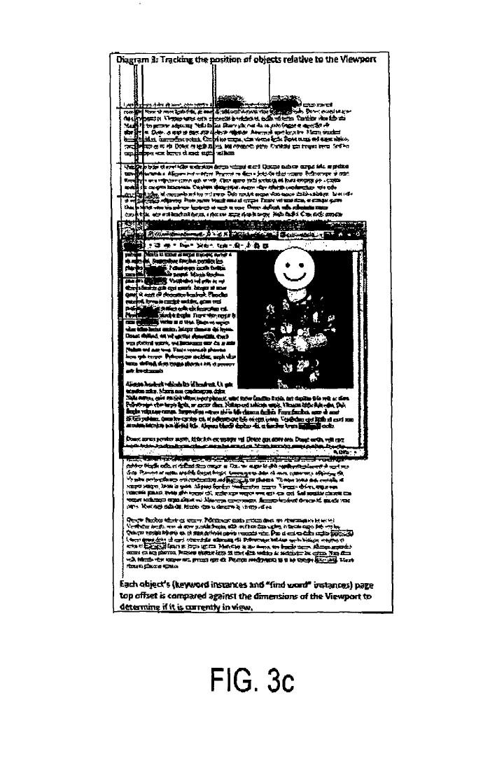

For the purposes of the present disclosure, a “viewport” is the window in a browser through which an HTML document's content is viewed. It is conventional to include a scrollbar in the viewport when the content is longer or wider than the available viewport space on screen. The illustrative example in FIG. 3a shows the initial state of a loaded HTML page, and instances of the term “dictum” which are present on the page. This is compared to the instances of “dictum” that are actually viewable through the viewport in FIG. 3a. Similarly, instances of the term “malesuada” are present on the page. However, only some instances of “malesuada” can be viewed through the viewport.

FIG. 3b shows another view of the viewport after the user has scrolled down the page a distance. After scrolling, there are additional instances of the term “dictum” that are newly visible through the viewport, and the newly viewable instances of “dictum” are added to previously viewable instances of “dictum” in a hash table. Similarly, instances of the term “malesuada” are also newly viewable, and the newly viewable instances of “malesuada” are added to the previously viewable instances of “malesuada” in the hash table.

Now referring to FIG. 3, shown is an illustrative example of tracking the position of objects (e.g., keywords, phrases or “find words”—words that are specified for tracking) relative to the viewport. As shown, each object's page top offset (i.e. the offset distance of each instance of a keyword, phrase or “find word” in the page) is compared against the dimensions of the viewport to determine if the object is currently in view. In an embodiment, a JavaScript Application Programming Interface (API) may be used to determine the viewport window size and the scrolling offset. A simple math calculation will allow the calculation of the exact position and area of the viewport, as well as every one of the objects being tracked. Each time a page is scrolled again, the present system and method can recalculate the positions to see if other keywords or phrases have come into or out of view.

The viewport utility of the present invention is best understood as a software utility that manages a viewport that operates in conjunction with use of a browser by a user. The “viewport” is a window or viewing area on a computer screen that defines the area that is used to consult an information object, such as for example a web page. Viewports have been used in the prior art to define an area of a canvas for a document that is smaller than the area of the overall canvas, so as to enable navigation within the document. The viewport in accordance with the present invention is used to extrapolate the area of interest to a user within a web page at a particular time, and based on keywords or images located within the area of interest, the keywords or images of interest to the user at that time.

A skilled reader will appreciate, that the viewport utility may be configured to detect certain parameters of a particular web page, including layout, web page type, dimensions of the web page, and based on this configure, or access a configuration of the viewport, for example that best enables inference of keywords or images of interest to the user on the particular web page at a particular point in time.

In one implementation, of the invention, the viewport utility is implemented so that the <html> element, which is the uppermost containing block of a typical web page, is constrained. An example may be used to explain this aspect of the invention. Assume a liquid web layout where one of the sidebars has a width of 10%. The sidebar grows and shrinks as you resize the browser window. This is possible because the sidebar gets 10% of the width of its parent. Let's say the parent is the body. Normally, all block-level elements take 100% of the width of their parent (there are exceptions, but these are not relevant for this example). The body may be as wide as its parent, the <html> element. The <html> element may be as wide as the browser window. That's why your sidebar with width: 10% will span 10% of the entire browser window. Theoretically, the width of the <html> element is restricted by the width of the viewport. The <html> element takes 100% of the width of that viewport. The viewport, in turn, is exactly equal to the browser window: it's been defined as such. The viewport is not an HTML construct, so you cannot influence it by CSS.

A skilled reader will appreciate that a viewer may be configured to detect and log interactions of interest using a mobile device as well. This is important and advantageous as current audience segmentation and ad targeting solutions use third-party cookies to track mobile users across various diverse web properties. The leading smartphone manufacturer (Apple) has recently announced that third-party cookies and device IDs will no longer be available for developers to make use of. This makes Ad Network's ability to track, segment and target users near impossible. With this technology, its ability to not only run using first party cookies but more importantly its ability to determine someone's interests while they are still on the same page, let alone the same web site will give marketers the tools they need.

One contribution of the invention, is the realization that what a user reads, particularly in a current browser session is a more accurate source of data to categorize a user as belonging to a marketing/audience segment than the prior art approaches that are based on a user visiting a particular web page. A skilled reader will appreciate that because many web pages include content covering two or more different topics, the present invention provides an improved mechanism to determine user intent or preferences based on consumption of internet content.

A skilled reader will also appreciate that prior to the present invention, data collection (for example for the purpose of internet advertising) has occurred from the vantage point of the server performing the data collection, rather than the user viewing web content. From the perspective of a server, a web page is a web page. Prior art technologies condense a web page into keywords, much as search engines do for example, but in so doing nuance of the content is lost because such prior art technologies cannot determine meaning of the content, nor the interest that the reader is taking in this meaning.

In contrast, the present invention analyzes the information that passes through a user's viewport of the present invention that is operable to define a portion of a web page that is visible at any one time through the user's browser window. This provides a more accurate set of data points for determining the subset of content in a web page that is of particular interest at a particular time, relative to the other content in the web page.

In addition, the viewport may be configured to monitor user behaviour in connection with particular content that passes through the viewport, for example (e.g. scrolling up to reread some text, highlighting content, where and for how long the mouse hovers over text or images).

The viewport utility of the present invention, in one implementation creates a log of time stamped events consisting of interactions between a particular user and selected content of a web page. This log provides the basis for analysis of user preferences.

In one aspect, the present invention enables the determination of preference information of a user based on their reading habits where preference information may not have otherwise been available. The computer platform of the present invention may identify for example that a user is interested in “computer games” or “travel”, based on analysis of their web viewing habits. A skilled reader will appreciate that this aspect of the invention is more useful where a single web page covers more than one topic or theme. For example a single web particle discussing pet insurance may contain both dog content and cat content. The computer platform of the present invention may detect that a particular user dwells more on dog content than cat content, enabling the determination that the user is more likely to be a dog lover than a cat lover.

A skilled reader will appreciate that the present invention enables a new and innovative computer platform and method for internet audience segmentation.

In one aspect of the invention, the computer platform of the present invention may be linked to a campaign manager. Campaign managers enable computer platform clients to define attributes of an audience segment, such as for example, “auto Intenders”—people who are in the market to buy a car. For example the campaign manager may enable clients to determine the keywords and phrases whose meaning and usage directly relate to the subject. A list of such words for this segment could include: car, cars, car loan, lease, sedan, convertible, sun roof, insurance, air bags, hatchback, and any number of brands and model names.

In one aspect of the invention, information relevant to a user's interest in these keywords or phrases may be collected, in a novel and innovative way using the viewport utility of the present invention, by initiating the viewport utility to use these keywords or phrases as find words for the user.

In another aspect of the invention, the user's interest in the keywords or phrases is logged by the computer platform of the present invention across multiple viewing instances in order to ongoing interest. A skilled reader will appreciate that numerous techniques may be used in conjunction with the computer platform, and the data sets made possible using the computer platform of the present invention. In one aspect of the invention, the computer platform is operable to analyze frequency, density, recency and other properties, including at historical, sessional, and page viewing levels, in order to determine likely interest of the user.

For example, the frequency of a user's interest in particular find words over time may provide insight into the user's longer-term interests, and therefore enable the determination of the user's participation in one or more segments. In this way, a skilled reader will understand that the present invention provides an audience discovery mechanism, which implemented as part of the computer platform of the present invention provides an audience discovery computer platform.

A skilled reader will also understand that the present invention provides a new and innovative mechanism for collecting information in support of user segmentation activities. Furthermore, the present invention may be used in conjunction with known techniques, including for segmenting users, for improving the results of such techniques. In other words, the inventor contemplates the use of the present invention in connection with various third party segmentation techniques.

In one implementation of the present invention, clients of the computer platform access a campaign manager component to create and name a segment, and add a list of phrases that they wish to be associated with that segment. The operator of the computer platform determines, or enables the client to determine, the scope of the campaign, thereby determining a group of users of the computer platform whom will be targeted as part of the campaign. The list of all words for the applicable one or more segments are pushed to a plurality of web server plugins implemented to web servers associated with the computer platform of the present invention. These web server plugins are operable to tag all of the words in the source html as it is emitted from the web server to the end user through the end user's browser.

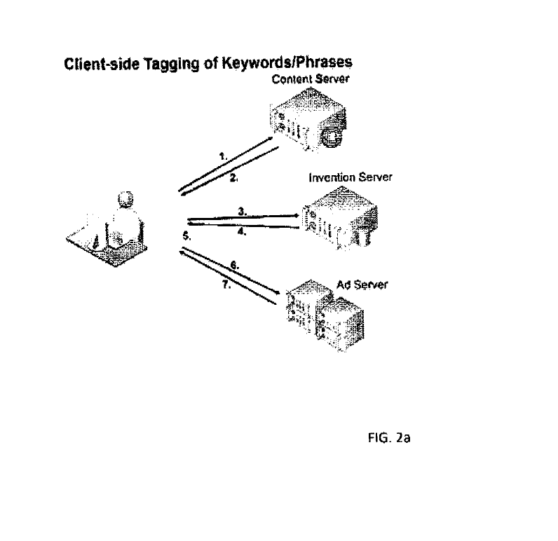

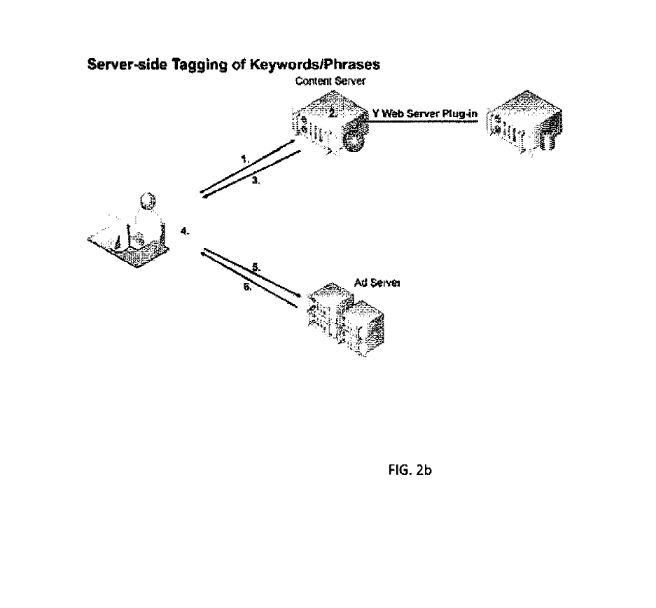

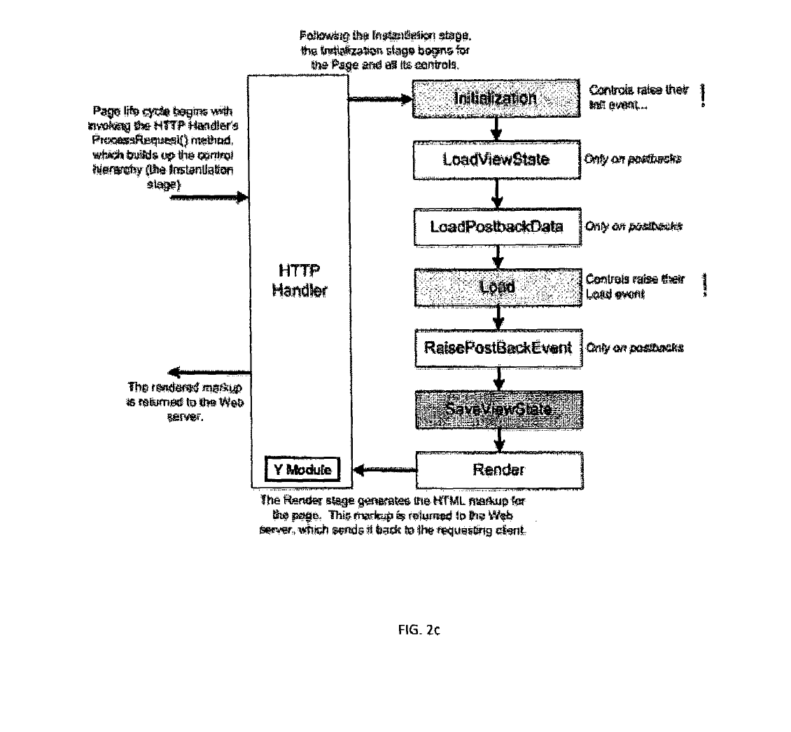

FIGS. 2a and 2b illustrates to examples of the implementation of the computer system of the present invention. More particularly, FIGS. 2a and 2b illustrate that the tagging of content can occur on the client side or on the server side, in two different aspects of the invention.

More particularly FIG. 2a illustrates the possible operations to enable client-side tagging of content. As shown in FIG. 2a: 1. Client calls web server for page; 2. We server returns CMS's HTML; 3. Client requests a JavaScript stub; 4. The data collection component returns a custom-generated JavaScript; 5. The data collection component executes locally, tagging Campaign Phrases; 6. The data collection component loads the appropriate Ad Tag to an ad server or to an intermediary; and 7. the ad server sends an ad to the client computer.

In accordance with the implementation shown in FIG. 2a the following implementation details may be noted. Name segment may be deployed within an ad server. The required tags may be to <HEAD> field for relevant web pages using the Content Management System (CMS). Ad targeting may be implemented as follows: 1. Create Line Item(s) in ad server; 2. Select Property (Domain) in a dashboard linked to the computer system of the present invention; 3. Create Data Collection Campaign(s) in dashboard linked to the computer system; 4. Repeat steps 2 & 3 for all properties; 5. Create Ad Optimization Campaign in the dashboard linked to the computer system; and 6.Deploy Y Ad Tag via AD SERVER.

FIG. 2b illustrates to service calls involved in a server side implementation of the present invention. The following system interaction steps are involved in the implementation of the present invention: 1. Client calls web server for a page; 2. the plug-in implemented to the web server Y Plug-in tags hundreds of Segment Phrases; 3. the web server returns HTML; 4. the plug-in writes first-party cookie listing segment codes; 5. ad Tag sends segment data ad server; and 6. Ad Server sends targeted ad to Client.

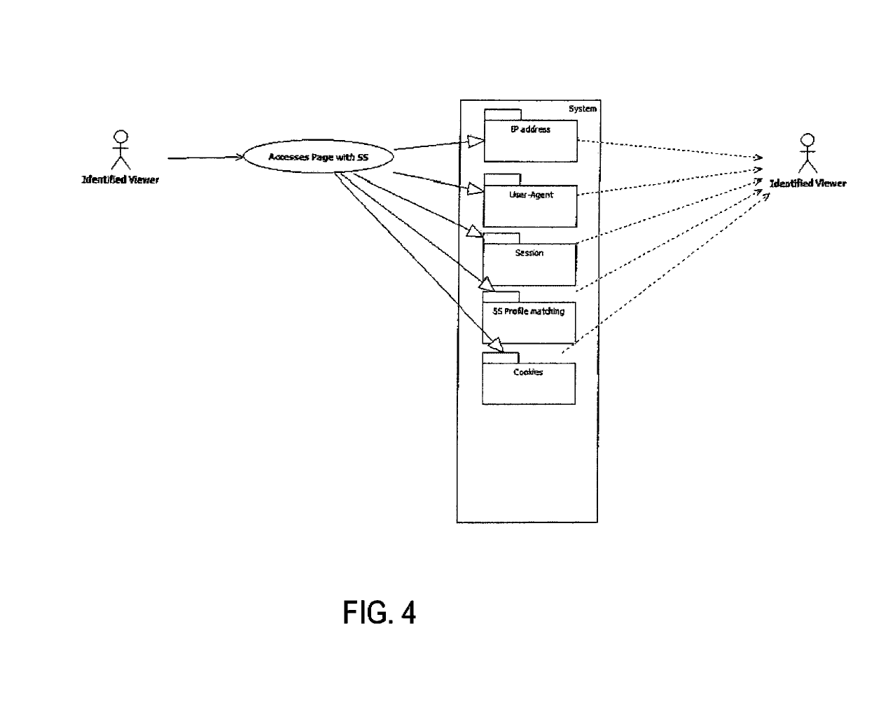

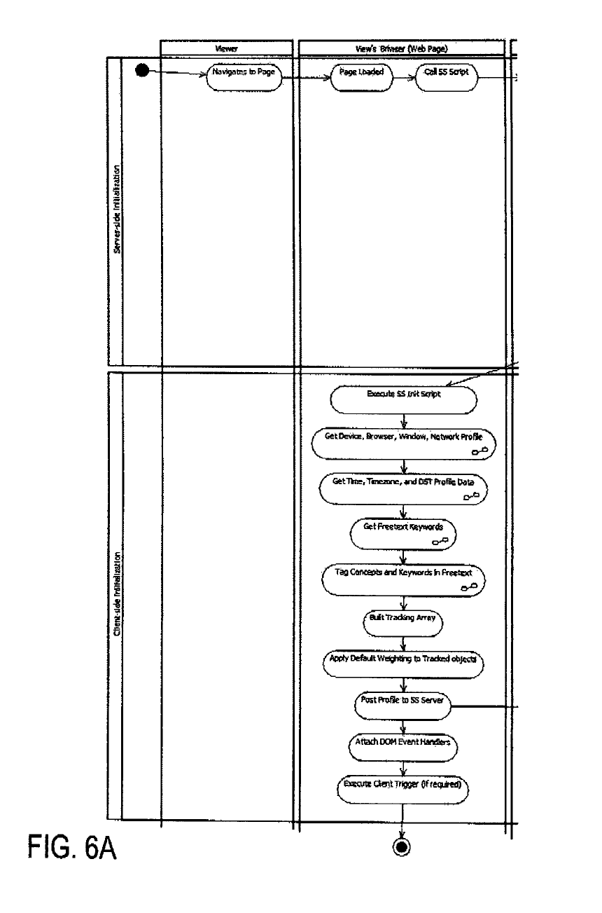

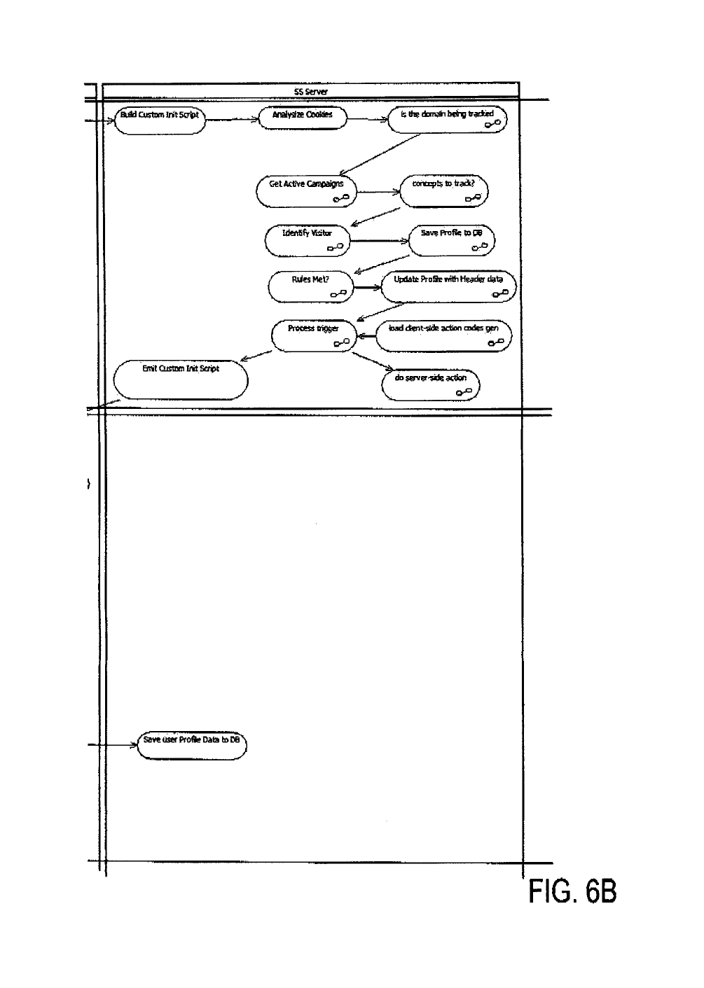

FIGS. 4 to 7B show schematic diagrams of various aspects of the present system and method, in accordance with various embodiments]

Semantic Knowledge Capture

For the purposes of the present disclosure, a “semantic knowledge capture” (or “semantic survey” or “SS” as denoted in some figures) is used to describe the method of the present invention consisting of analyzing a user's browsing behaviour by collecting information on what objects a user or a viewer is focussed on when viewing a plurality of pages within a viewport. As will be explained in more detail below, semantic knowledge capture facilitates a real-time or near real-time viewport analysis, whereby the content that is presently viewable within a viewport of a user is analyzed for example for keywords, relevance, and click-streaming. From this analysis, the present system and method derives in real-time, or in near real-time, which concepts or ideas a user is interested in. In contrast, conventional click-stream analysis and existing search engines generally try to analyze an entire HTML page's contents for keywords, relevance and click-stream, making it significantly more difficult to determine what concepts or ideas the user is focussed on in particular. Especially in relation to web content that relates to a number of different concepts or ideas, which is the case for a substantial amount of web content, prior art approaches do not yield sufficient insight into the specific nature of the user's content, or the particular ideas or concepts within the web content, or portions of the content, that are especially of interest to the user.

In accordance with an aspect, utilizing semantic knowledge capture, the present system and method aggregates analytics information based on derived concepts or ideas associated with a user's browsing, as opposed to analyzing the pages themselves in great detail. The results indicate more clearly what is of particular interest or importance to a user.

A skilled reader will appreciate that semantic knowledge capture in accordance with the present invention may be used to track a user's point of focus across multiple pages and across multiple websites in order to enhance the understanding of what the user is looking for In this aspect of the invention, one or more web servers associated with the multiple pages across multiple websites include or are linked to the plug-in described. The analysis may be based, for example, on identifying like concepts and recurring keywords, phrases of “find words” within the viewport. To the best knowledge of the inventor, no one has previously analyzed viewport related user events in this way. In contrast, a traditional click-stream analysis generally attributes a dataset to a single page, and performs analysis for the pages visited.

As shown in FIG. 1, the computer system may be configured in a client-server arrangement, where the central server (24) r computing device hosts modules for performing analysis and for storing data collected from a plurality of client computer devices (12). On the server side, there may be large amounts of data that may require merging, de-duplication and analysis. Data collection and basic analysis may occur on the client-side. With each relevant user action (e.g. scrolling the viewport to view different parts of a page, or making a selection of text, or clicking on a link), data is transmitted to the database.

Alternatively, in order to conserve and optimize bandwidth when communicating data to the server, the system may queue and remove data transition events if they are too close in time to a previous one. The handling of contextual data is different than that of the session data. The session data is recorded once before user engagement.

One particular aspect of the invention, when a page loads into a viewport on a client computing device, the present system and method may use one or more routines which may be implemented using one or more algorithms to analyze the viewable page content in the viewport to rank keywords, phrases and “find words” in a hash table. The nature of the keywords as they relate to the HTML/JavaScript Document Object Model (DOM) is also recorded. The hash table is sent then to the server where the semantic knowledge capture algorithm gives a weight to each keyword (or key phrase) based on its hierarchy in the DOM (e.g. Document Title, Keyword & Description meta-tags, H1, H2, H3, H4, H5 tags, Bolded content, underlined content, italicized content). In one particular implementation, a client script running on the client computing device (12) continues to send updates to the central server (24) on the number of times a keyword has come into view within a users viewport. Additionally, a client-side algorithm (which may be implemented to the analyzer (20)) may add weight to a keyword increment counter with respect to scroll direction or activity. For example, a larger value may be assigned to scrolling back up to see something, versus scrolling down to discover it the first time. The scrolling distance may also be taken into account.

In one aspect of the invention, the present system and method may utilize a hash table of keywords based on HTML tags such as keyword meta tags, and heading tags. In addition, particular words or phrases may be specified on the server side of the system to track multiple users on a plurality of client computer devices (12).

The present system and method may also perform a full page context analysis to calculate keyword density when a page first loads for viewing in a viewport. The system and method may then analyse the full page content and use metadata to prepare a list of relevant and important keywords. Subsequently, when following the activities of a user viewing various pages through a viewport, the system and method may record instances of these keywords occurring in the hash table.

Significantly, the present system and method can score how many times a user has viewed a vkeyword or phrase or HTML object resulting from the full page context analysis, or based on other keywords and phrases added to the hash table. In one particular aspect of the invention, hash table results for pages viewed through the viewport are transmitted via web services from a client computer device (12) to a hash database (not shown) linked to the central server (24). Thus, instead of just tracking the pages looked at, the present system and method can determine how many times a user has viewed particular words or phrases displayed through a viewport, and/or how long they remained in view.

In one particular aspect of the invention, the system and method may use HTML tags, such as heading tags (H1, H2, . . . H6), as an indication of document structure. The computer system may be configured to apply a weight to each heading tag, and the weight may be applied to modify the value of a keyword or keywords when added to the Hash table. For example, suppose a page includes a H1 heading (main topic of the page) and then lower clown in the page, the page includes a H2 heading, and then introduces a small body of content. The algorithm takes into account the page structure based on the heading tags, and allows customers to override the logic and apply their own weight scheme to their own information. Some may use headings instead of layout as a design preference.

In one particular implementation of the invention, when a page loads in the browser of a viewer's client computing device, a client-side JavaScript script is called, loaded and executed. This script may be custom generated for each unique page view. By calling this script, the present system and method can determine various attributes of the user such as if the user has been previously identified, has identifying cookies, or has a current session open, for example. identifying data is processed for the user, and a custom JavaScript is created for the user, and the specific page they are about to view. The script may implement a routine that analyzes the page content for keyword density, and may also search and locate any pre-defined words or phrases that have been identified for tracking (e.g. as pre-configured by the client using a web-based tool). These “find words” may be compiled into the JavaScript server-side as the custom JavaScript was emitted for download. In determining the keywords on a page, the computer system may be configured to check the keywords against a list of known “stop words”, i.e. words from a list that search engines are generally programmed to ignore, both when indexing entries for searching and when retrieving them as the result of a search query. An example, in most search engines is the word “the”.

In an example of an implementation of the present, the top ten keywords plus the “find words” are added to a multi-dimensional array which records their initial horizontal (X) and vertical (Y) offset from the top of the page, the dimensions of the viewport, and also applies an initial base weight. Weighting may provide an “importance” or “relevance” factor. For example, an instance of a word in a heading may carry more weight than if the word was in content. The algorithm may then rewrite the HTML to add unique identifiers to the HTML ID property for each instance of the keywords and find words being tracked in the web page.

In another aspect, the present invention tracks subsequent positions and timings of the keywords.

In a particular implementation, the computer system is configured to identify which of the tagged keywords is currently visible in the viewport as described above. This system operation may be called as a part of the initial semantic service loading sequence, but can also be called each time a window scroll or paging event and/or custom events, has occurred in the user's browser. With each event, the computer system may not only track whether an object is in view, but also the user's behaviour or actions with respect to how the object came into view, and how long the object remained in view

“Custom events” refer to the ability of the computer system to intercept and capture certain client-side JavaScript API events for the purposes of targeting a data collection and/or marketing action. For example, the custom events can be from the HTML DOM (e.g. onclick( ) when a viewer clicks on a hyperlink, or mouseover (when they rollover an object like an image) where a web master can integrate the described JavaScript API to record the completion of more complex events (e.g., someone fills in more than 2 fields in a form).

By way of example, a user's behaviour that may be used as input to the computer system includes:
Time on viewport (without scrolling); i.e. how many milliseconds was it visible for.
Scrolling speed to arrive at newly visible content
Scrolling distance to arrive at newly visible content
Scrolling direction (scroll down the page vs. scrolling back up the page, plus horizontal scrolls if any)
Scrolling direction pattern
Arrived via window scrolling vs. inline HTML anchor navigation link
Special server-side weighting instructions
optionally adding capturing magnification, for example using a mobile device; and
Add custom events via JS API created by customers (e.g. type of form field).

Once the initial semantic knowledge capture loading sequence is completed, the current values of the multi-dimensional array, along with another dataset of relevant data (e.g. the web pages meta tag content, the content author, the page URL, and other client-side technology values) may be transmitted to the central server (24) via web services for data collection. After each subsequent calling of the tracking features of the computer system, the updated multi-dimensional array data is again transmitted to the central server via web services for data collection.

In an aspect, there are a variety of outputs from the tracking performed by the present system and method that may be used for a variety of purposes. Those purposes include, but are not limited to:
Cookies to track whether an individual already has a unique semantic knowledge capture User ID, their current Semantic knowledge capture Session ID, and Session Start Time.
Properties derived from client-side technologies such as JavaScript, Java, Flash, etc.; these may be used to both gain further analytics of a user's environment (OS, Browser, Browser Version, Plugs, Fonts, Time zone, language, etc) and also as a measure of browser uniqueness to help identify return users who have cleared their browser cache.
Data garnered from the semantic knowledge capture user content viewing tracking program.
All server-side HTTP transport header properties

Cookies, header properties, and client-side technology derived properties are all collected, transmitted, and collected as key-and-value. This information may be saved to a database configured to store semantic knowledge regarding users, which may be linked to the central server (24). Cookies and headers transmission is a function of the web browser. The additional properties may be posted to the central server (24) for example using an AJAX call (to a web service) triggered upon the completion of the data collection functions and any related analytical operations on the client side.

Semantic knowledge capture compares the results (along with the consumer's entire recorded history) against a set of client-created triggers, as well as rules and triggers that may be related to audience segments and uses this information to call up real-time, contextually relevant actions. Each time a consumer scrolls, new events are continuously being sent to the central server, capturing consumer behaviour within a page as well as across the web site, session, and browser history. Thus, an administrative utility may be provided where an administrator/developer can set up their requirements, and then initiate the presentation of dashboards or screens for particular behaviour or preference tracking. This aspect may be implemented as part of dashboard (30).

An action can be a basic command, such as ‘display coupon’, a logic tree of questions or a complex cascade of actions. Such actions include, but are not limited to:
Posing a single question, for example in the form of an inline poll or poll overlay
Presenting an interactive survey
Connecting to an internal application
Calling an internal knowledge application tool
Transmitting data to another database
Emailing an alert
Changing or adding ads from an ad server;
Changing/adding content or media

In a particular implementation of the invention, the plug-in rewrites outgoing HTML in order to tag the instances of named keywords and phrases. A viewers membership within a segment is determined by counting the frequency, recency, and volume of keywords viewed from a segment. Ad Servers are given the list of a viewer's Segments via a first-party cookie (or JavaScript, or web services) and then relay on their own internal targeting capabilities. In this fashion, the computer system of the present invention is not only ‘resource neutral’, but also makes use of the innate targeting, forecasting, and workflow of a customer's existing Ad Server platform.

Deploying the computer platform of the present invention is quick and easy. For example, in one implementation, a client simply downloads and installs an applicable web server plug-in (depending on software used on the web server); and generally a Dynamic-link Library (DLL) for Microsoft IIS, or an Apache HTML Server plug-in for most other implementation. For .NET web sites, there is an additional step of adding a reference to an HTTPHandler in the site's web.config file.

Both the .NET DLL and the Apache HTTP Server Plug-ins operates as a module within each web server. The module is loaded by the web server at startup, and then certain HTTP requests are delegated to it.

The function of the module is to rewrite relevant portions of the outgoing HTML; specifically, it lags” all instances of client-specified words and phrases that occur in the content of the web page by wrapping them in a <SPAN> tag which is invisible to the end-user. Each span tag is further given a unique ID attribute for each instance of key-phrase tagged.

The modules function does not interfere with dynamic content creation, occurring after the page creation life cycle, but before the plain text of the HTML is emitted by the web server. The module (and its rewritten outgoing HTML) supports compression and caching, and has a very light footprint; never adding more than 1 Kb of text to the page.

The benefits of tagging keywords on the server-side rather than the client-side are that tagging does not become bound by the performance of the receiving device. It also serves to optimize page load times by reducing the number of requests the viewer's browser is required to complete.

The plugin, in one implementation, contains two bodies of code. The first is the open-source Amazon Web Services AWS .NET Library, which is used to request the list of active key-phrases from a SimpleDB table. The second is the Applicant's own library.

Applicant's custom code's only purpose is to parse the html text and to tag the key-phrases. It is accomplished using a combination of StringBuilder functions and Regular Expressions. The algorithms parsing the text ensure that only free text is touched, and not the page <head>, script tags, style tags, object tags, etc.

Clients may create as many Segments and Sub-segments as they wish using the dashboard. Creating a segment is as easy as giving it a name, and the providing a list of keywords and phrases that describe it. Keywords may appear in as many segments as you like—E.g. the phrase “pet insurance” may be used for Segment called “Pets”, and also for one called “Insurance Intenders”.

Basic integration of the computer system of the present invention with an Ad Server is quick and easy. For example, leading Ad Servers, such as DoubleClick for Publishers and AppNexus, allow customers to pass in custom variables (for ad targeting) via a JavaScript API. The computer system of the present invention writes a list of a viewer's segments into a first-party cookie which can be integrated with their API by adding a single line of JavaScript to a web page. In most cases, the Ad Server is able to simply read any first-party cookies automatically.

The plug-in of the present invention, in one implementation uses HTTP-tunneling, a technique which allows HTTP requests and responses access through a company's firewall can also operate through the plug-in, providing non-browser clients access to Y's servers and data.

Actions may be based on the analysis of page headings, keywords, content, and consumer viewing behaviour. Semantic knowledge capture tracks all consumers' behaviour, not just subscribers or email respondents, Semantic knowledge capture installs a cookie for every consumer, no matter who they are.

In another aspect, based on a server side analysis, the system and method can in real-time, or in substantially real-time, transmit content and or actions, or change content or ads (for example), to be executed on a user's browser. This content, or actions, may comprise a suggestion, question, or calling upon another application, etc. Questions may be derived from survey logic trees populated by the clients and server side analysis to determine starting point and progress.

Enterprise Knowledge Capture

A skilled reader will understand that the computer system of the present invention may also be used in an enterprise environment in order to capture semantic knowledge by configuring the system of the invention to collect information about individual users in the enterprise, and store this information in a computer system that may be configured to operate as a knowledge engine. From a management perspective there is often a gap between best practices, manuals, governance policies, procedures, and so on, and how things are actually being done the institutional memory, the “deep smarts”. A way to capture institutional knowledge and memory is needed.

The present system and method may be utilized to assist with the capture of institutional knowledge and memory. For example, if a user is looking at certain things a certain number of times—and this is analyzed on the server side—the present system and method can estimate a user's knowledge in a certain area based on how much time they are spending on certain browsing activities. This may also be described as a “knowledge quotient” or “KQ”.

Thus, the present system and method may utilize semantic knowledge capture to collect useful information about a user's knowledge and experience in how they may perform particular tasks. Thus, a semantic knowledge capture may be used to capture a user's knowledge as they go about performing tasks or developing subject matter through interactions with their computer device.

Advantageously, people will be trained faster because one can see responses to certain questions, and digests thereof, such that the knowledge engine may enable for example “a knowledge blog” that would allow other users to quickly get up to speed in performing a particular task. The knowledge blog may also capture a particular person's personal history of questions, responses, arrangements of content.

The present system and method does not just ask questions in a linear fashion like conventional surveys. Rather, with the present system and method, it is possible to develop cascading logic-based questionnaires that have multiple entry points based on the content the user is viewing.

In a particular implementation, entry points may be matched to viewers based on questions, subject matter and the user's real time KQ.

Where information has been solicited from the end user (i.e. the viewer/consumer); a Heuristic Engine (“HE”) analyzes the answer to the question for symbols (words become objects, then symbols, they types, etc.). These symbols are compared to an established taxonomy of verbs, nouns, including actions, people, places, institutions, locations, and other metadata. The HE works in conjunction with the cascading logic tree to determine if there is any action/reaction required by the system.

A cascading logic tree driven by the system of the present invention may include a collection of questions that have causal relationships dictated by rules and semantic patterns designed by an administrator/developer using the dashboard (30).

Suppose an administrator/developer wants to collect information about a particular topic/concept(s). First, they create a cascading logic tree that may be called a “Campaign”. Consequently, this is more general, and not a specific survey anymore.

In one example of an implementation of the invention, the cascading logic tree is managed by rules and triggers. Users proceed through this campaign by having their data applied to the campaign to determine if appropriate rules and triggers should be called. A rule may consist of a a defined pattern of desired user or viewer behaviour and/or viewer data (with or without defined parameters with respect to how the data was collected). Rules can include combinations and variations of keywords, page hits, page location, and geographic location, and can further take into account: density, frequency, timing and sequence. If the rule is met, then a trigger calls an action, including: posing a single question, presenting an interactive survey, emailing an individual an alert, etc.

In the case where a question is posed and an answer received, the HE mayl analyze the result to determine if the result should call up another campaign. The automatic profiling may consist of a ‘predetermined campaign’ for specific purposes such as: HR profile, Business Continuity Planning, etc.

In an enterprise context, the present system may include template campaigns already designed to fill out individual corporate HR, skills, C.V./resume related profiles deployed in a low impact, low frequency manner over time. The answers may be posted to a searchable knowledge base to which administrators may have full access. Corporate users may be given access to see the profiles of others that are related to their role/function in the company.

By collecting the information, the present system and method may be used as a tool to assist management. By giving the users access to the information, the present system and method may provides the basis for collaboration.

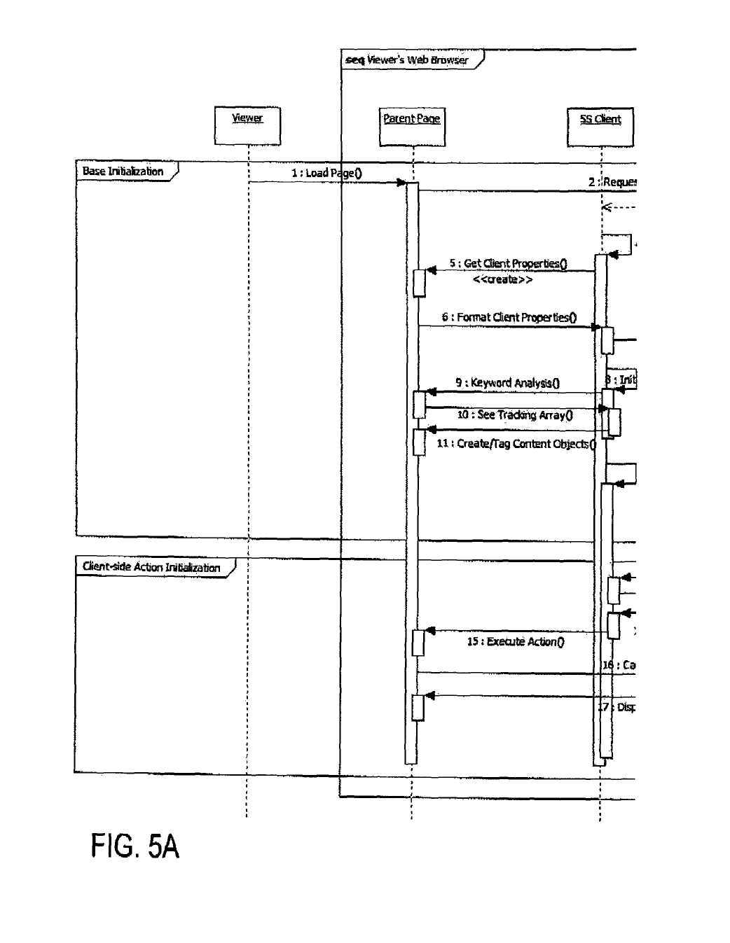

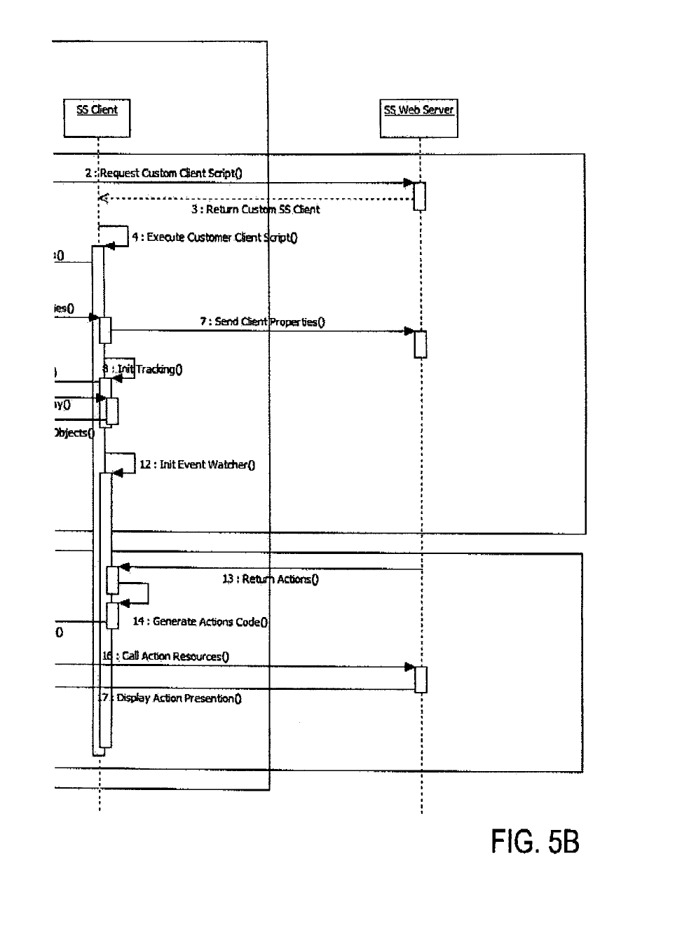

Now referring to FIGS. 5A and 5B, shown is a schematic diagram of another aspect of the system and method in accordance with an embodiment. As shown, FIGS. 5A and 5B show a base initialization step, a client-side action initialization, and a sequence of steps performed via a user's or viewer's web browser. At Step 1, the viewer initiates a load page, and arrives at a parent page.

From the parent page, at Step 2 a request is made to obtain a custom client script for the user or viewer. Next, at Step 3, in response to the request, the server may return a custom script with a list of specific words, etc. that the user/viewer is interested in, regardless of where the words may rank in the loaded page. Next, at Step 4, the custom client script is executed by the client module. At Step 5, the client module gets the client properties, and at Step 7, the client module formats the page using the client properties. This initializes the tracking at Step 8, and also initiates the keyword analysis of text content within the loaded page at Step 9. The text content within the page is unstructured data, thus it needs to be analyzed and processed, including viewing a tracking array at Step 10. At Step 11, content objects are created and tagged. Instances of keywords or phrases are then ranked in order to develop an index of key words (e.g. the top ten keywords).

At Step 12, an event watcher is initiated so that an event system receives push notifications whenever an event occurs. These events are user activity events including navigating, scrolling, paging, etc. in the page and off the page. Whenever the page moves relative to the viewport, this is considered to be a user event and is logged as such. A series of computer system features may be used to help interpret intent through weighting. For example, if a user scrolls up and then down, and continued to go down, this may be interpreted as the user having gone back to re-read something on the page. The computer system may be configured to heuristically analyze human behaviour in viewing a page to weigh the content that they are viewing. In contrast, traditional search engine indexing is interested in views of the entire page or ad. Therefore, they don't care about user events as described.

In a particular implementation of the invention, a semantic layer could also be added. As an illustrative example, an analytics tool such as Pagerank may analyze the content of the pages. Pagerank has a semantic layer built in that analyzes the content and the natural language context, and thereby they can provide a value of that page relative to a specific text thus placing greater value on sites that actually provide meaningful content related to a specific topic. With such a tool, the present system and method finds out what ideas the user/viewer is trying to pull out from the page. Semantic analysis could be used to select the relevant HTML objects. A skilled reader will understand that a various other tools may be used in combination with the present invention.

At Step 13, a client-side action initialization may originate from the server, and instruct the client to generate an action code for one of the actions, as described earlier. The client can then execute the action at Step 15 on the page. Action resources may then be called at Step 16, and an action presentation may be displayed at Step 17.

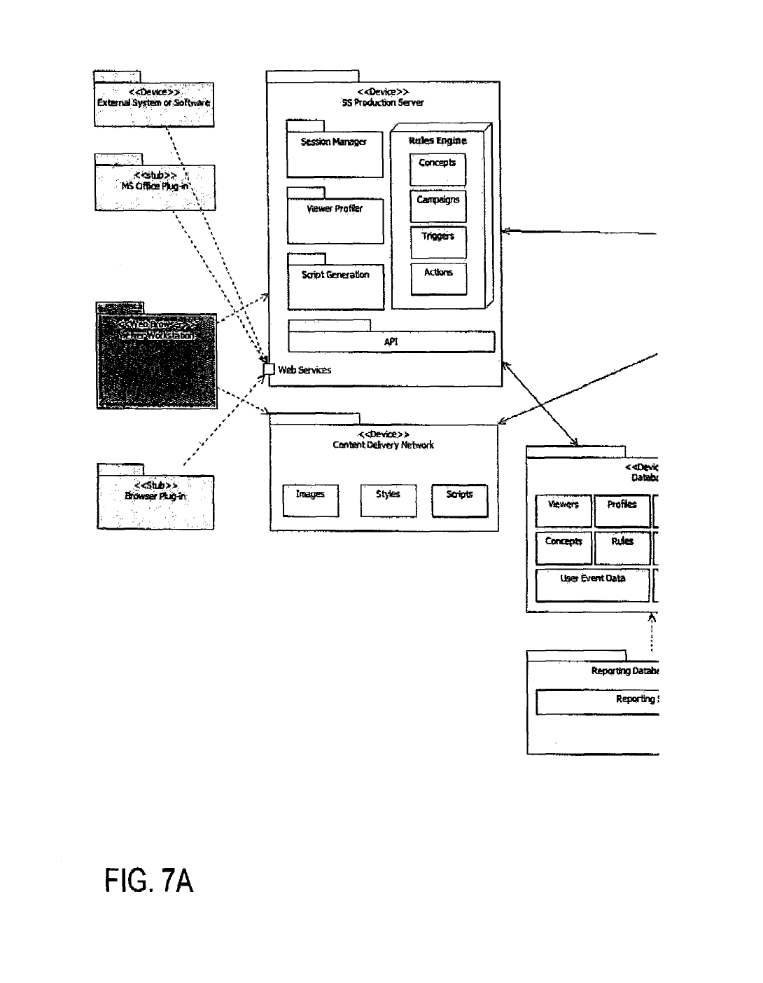

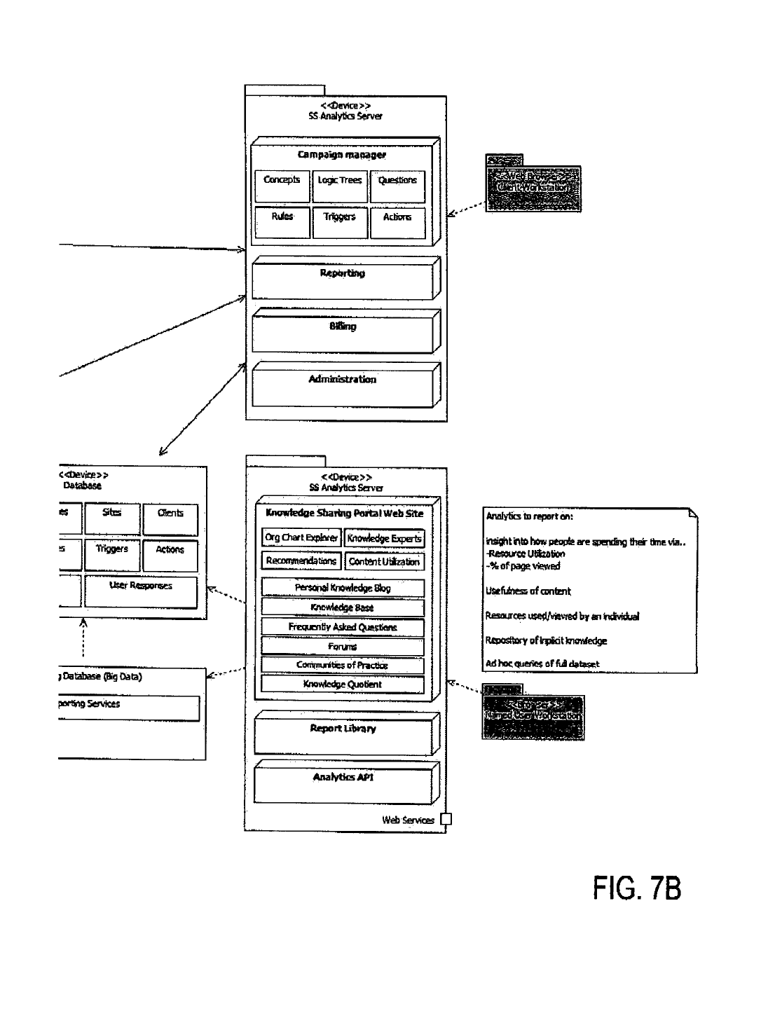

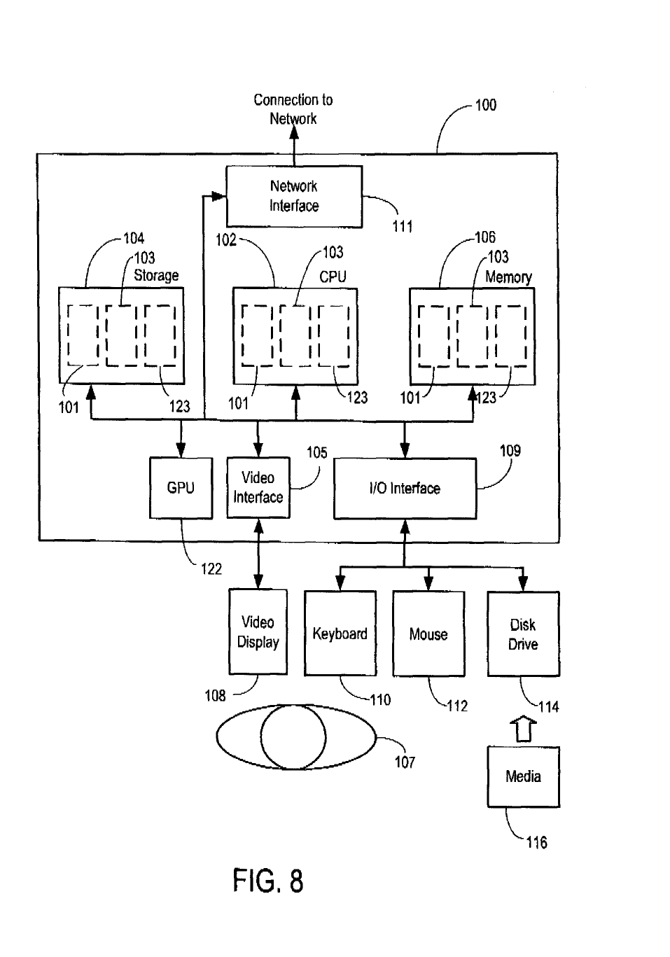

Now referring to FIGS. 7A and 7B, shown is a schematic diagram of another aspect of the system and method in accordance with a particular aspect of the invention.

For the purposes of referring to FIGS. 7A and 7B, it is useful to define the following terms:

Viewer(s) (or users, as referenced above) are people who are either:
a) Viewing a web page that has the semantic knowledge capture JavaScript tracking code pasted into it
b) Viewing a Microsoft Office document where an add-in configured to interoperate with the present computer system has been installed.
c) Viewing content in a remote computer where a semantic knowledge capture Application Program Interface has been integrated into the solution.

Clients)—A Client is a person or business entity who has registered for semantic knowledge capture for the purposes of integrating its features and functions into their external web site, browsers, web sites, Apps, or systems.

End User(s)—collectively, all users of semantic knowledge capture's full features and functions are referred to as End Users. This includes Viewers and Clients, but excludes Administrators.

Administrator(s)—Administrators are authenticated Semantic knowledge capture personnel who may access the back office functions of the site/solution for client management, communications, marketing, sales, billing, and other administrative requirements.

Client-side—Client-side implies all code and content that resides (or is being viewed) on an End User's device.

Viewer Interaction Channels—A variety of devices, systems, or software may be employed to integrate the Semantic knowledge capture tracking services, which collects keywords and key phrases (we call them “Concepts”) that Viewer's are viewing. Some of these channels may also facilitate semantic knowledge capture ability to interact with End Users directly through the very interface they are viewing the content with.

Web Browser-enabled Device—in one particular implementation, users of the computer system and related web service and its offerings are browser-based, Viewers may access web pages that have semantic knowledge capture services installed via a web browser. The web browser may be on any browser capable device (e.g. laptop, net book, workstation, desktop, ‘Phone, iPad, Android devices, Windows Mobile devices, etc.). Installation of semantic knowledge capture consists of adding tracking code to each web page in a web site. The tracking code calls up a JavaScript generated by the Production Server. Viewers will use their browser to access pages of web sites. Clients will log into the Client Administration Server web site.

External System or Software (50)—semantic knowledge capture may be implemented using Application Program Interface (API) and Software Development Kit (SDK) to facilitate third-party (Client) developers integrating the semantic knowledge capture feature set and functionality into their compiled software, Apps, or other standalone systems and/or software. ‘Thin Client’ to Server communications will be handled JSON Web Services calls.

MS Office Add-in (52)—A Microsoft Office™ Add-in may be provided to track and report on viewer keyword viewing within Office™ documents, extended the reach of the end-user knowledge capture aspects of semantic knowledge capture. ‘Thin Client’ to Server communications will be handled JSON Web Services calls. A skilled reader will immediately understand that add-ins may be programmed to enable the data collection through various other applications, and then the use of the data collected for the purpose of semantic knowledge capture, as described in this disclosure.

Browser Plug-ins (54)—browser Plug-ins may be developed for all leading browsers so that End Users can integrate and use semantic knowledge capture's features and functionality without having the need of the host web sites having installed semantic knowledge capture. Thin Client' to Server communications will be handled JSON Web Services calls.

Production Server (56)—the computer system may include a semantic knowledge capture Production Server (56) that may be implemented as acollection of web servers working together (i.e. web farm) as Application Server (58). The Application Server (58) may be configured to serve the needs of various forms of Viewer interactions with semantic knowledge capture. All client-side component may communicate with the Production Server (56) via JavaScript Object Notation (JSON) Web Services and/or by the POST method in HTML. The Production Server (56) may be implemented to enable Client-created Knowledge Campaigns that are configured on a client administration server, and may be stored in the Semantic knowledge capture Database (60). The Production Server (56) may include a number of sub-systems, in one implementation of the invention, which are listed an explained below.

Rules Engine (62)—The Rules Engine (62) may execute one or more business rules in the runtime production environment. The rules may be created by Clients on the Client Administration Server (58) to create Knowledge Campaigns that collect Viewer analytics on client-defined Concepts. The rules for these tracked concepts may be grouped into a Campaign. If a Rule (or (62) group of rules) is met, it will trigger a client-side or server-side action. The Rules Engine parses the incoming real-time and historical analytics data to determine if a rule has been met. And, if it has been met, it will trigger the appropriate action(s). A client-side action may include calling the Script Generation sub-system (64) to compile and push out functionality (e.g. ask a question) or content (e.g. a limited time discount coupon) to the Viewer's browser in the form of JavaScript and images.

Session Manager (66)—Semantic knowledge capture may be implemented in both open and closed systems. An open system (e.g. commercial/public web sites) will anonymously identify unique visitors. A closed system (e.g. a private enterprise intranet or web-based systems) will link unique visitors to a known Directory Services user profile. The Session Manager (66) is the sub-system that monitors both the interactive information interchange between the calling web page and the Semantic knowledge capture scripts they call, as well as that dentifies and uniquely tags the individual viewers.

The Script Generation (64) sub-system may be configured such that a tracking code is placed in unique Client Account ID. However, it primarily serves to call an external JavaScript file which is ultimately generated by the Script Generation sub-system (64). The Script Generation sub-system (64) works hand-in-hand with the Rules Engine (62) to include any client-specific campaign data which must be included in the tracking code to be executed client-side. Each script, therefore, is tailored to each unique page view, for a unique Viewer, on Client-configured web sites. The Script Generation sub-system (64) will also work closely with the Action Manager (68) sub-system (see more detail below regarding this sub-system) to build the JavaScript code required to dynamically build and run HTML and programming that runs client-side in response to a called Campaign Action (e.g. a survey question),

Viewer Profiler (70)—The Viewer Profiler sub-system (70) tracks the unique (and changing) characteristics of the Viewer's hardware, software, and system. Such information includes the type of hardware, the operating system, monitor dimensions, system time zone, etc. This information is used for both traditional web site analytics, but also as secondary keys for the Analytics Database's ‘User Profile De-duplication Service’ sub-system.

Actions Manager (68)—The Actions Manager sub-system (68) is called by the Rules Engine (62) when the conditions for a Rule (or group of Rules) are met. Actions may be either server-side (e.g. send a named contact an email with dynamic or defined data) or client-side, such as posing a Viewer an offer, information, or a survey question.

In order to have a client-side action execute within the Viewer's browser, the Actions Manager (68) in one implementation will need to call the Script Generation sub-system (64), and then coordinate the delivery of the generated script to the Viewer's browser through the Viewer Interaction Processor.

Viewer Interaction Processor—The Viewer Interaction Processor is the sub-system which records the incremental, event-based data the tracking code is capturing. ‘Viewed Concepts’ data, as well as any Viewer responses to client-side actions (such as survey questions), are recorded. The results from both processes are sent to the Rules Engine (62) for post-processing in case the data therein triggers a Rule.

Application Program Interface (72)—An Application Programming Interface (API) (72) will be created so that applications, libraries, and operating systems can integrate semantic knowledge capture's functions and feature set. The API (72) will include routines, data structures, object classes, and protocols used to communicate between external programs and semantic knowledge capture's system. For example, a Windows-based API for Microsoft .NET Framework development would be available in the form of pre-compiled code Dynamic Link Libraries (DLL's). Developer support may be made available in the form of a Software Development Kit (SDK), providing documentation, code examples, and tools necessary to build software based upon the semantic knowledge capture technology and services.

Web Services (74)—a web tracking code, as well as all other forms of Viewer Interaction integration may use Web Services to communicate with the semantic knowledge capture system. Services may be offered in both Simple Object Access Protocol (SOAP) for systems, and Representational State Transfer (REST) based communications for Web Sites and Apps.

Content Delivery Network (76)—A Content Delivery Network maybe employed to maximize bandwidth for access to all static system data and files from client web sites throughout the world. Such files would typically include: images, JavaScript, cascading styles sheets, and some form of HTML pages (e.g. .php, .aspx, .html, etc.).

Application Database (78) an Application Database may be used as the primary means of entering and recording data for the semantic knowledge capture solution,

Analytics Database (80) (Big Data)—The Analytics Database (80) may be implemented as part of the Application Database (78) whose purpose is to provide Big Data storage for post-processing and reporting.

User Profile De-duplication Service (82)—The User Profile De-duplication Service sub-system (82) is configured to parse the Profile data in order to find and merge multiple Profile datasets which may, in fact, represent the same unique Viewer. This can be a common occurrence as Viewers may periodically clear their cookies—the primary means with which semantic knowledge capture identifies and tags unique Viewers.

Business Intelligence Tools (84)—The Business Intelligence Tools sub-system will provide the means for Administrators and End Users to generate analytics and reporting on the Viewer Interaction Processor's recorded data.

Business/Client Portal Server (86)—The Business/Client Portal Server (86) is a web site where customers can register to become Clients of semantic knowledge capture and further author and manage their account, billing, and Knowledge Campaigns. This server will further offer back-office capabilities for semantic knowledge capture Administrators to communicate, market, and manage prospects and Clients.

Knowledge Campaign Manager (88)—The Knowledge Campaign Manager sub-system (88) is the interface where Clients create their Knowledge Campaigns. A Campaign is a logical wrapper around a collection of Client-defined data collection and Viewer interactions (for a stated purpose). A Campaign has a list of Concepts, which are Keywords and/or Key Phrases which the Client wants to collect Viewer metrics on. The Client may then create a Rule or Trigger (a Trigger is a group or collection of Rules). The Client also defines what Action(s) should be taken if all of the conditions of the Rule(s) are met i.e. all of the Rules equate to ° true”. Some examples of Triggers are now provided:

### EXAMPLE 1

Trigger: “LED TV Promotion”
Rule 1: Visited a specific page (URL).
Rule 2: Has Find Word “LED” view count >30 within the 7 days (period).
Rule 3: Geographic location is North York Ontario (derived from user's IP address).
Rule 4: Viewed more than 5 pages on site
Rule 5: Interact ‘offer only once’
Action: Present Coupon Offer for Best Buy on Wilson Ave (specified content).
   Settings: Limit 1 per User
   Settings: Maximum 25 offers
   Settings: Present only to 1 of every 5 qualified Users

### EXAMPLE 2

Semantic Survey: “Learn about Sony LED TV's”
Question: Would you like to learn more about Sony LED TV's?
   Follow-up Question (if yes): Do you watch a lot of sports?
   Follow-up Question (if no): Present custom content “{list of relevant URLs for more info}”

Settings: Only one survey may be active at once per user

Trigger: “Sony LED TV Survey'
Rule 1: Has Find Word “LED” view count >30 within the 7 days (period).
Rule 2: Has Find Word “LED” view count >30 within the 7 days (period).
Rule 3: Geographic location is Canada (derived from user's IP address).
Rule 4: Interact ‘offer three times in a row’
Action: Initiate Semantic Survey “Learn about Sony LED TV's” (pre-defined elsewhere)

Certain Actions are pre-defined; such as presenting Views with a question. Others have more free-form presentation. Clients can create a network of semantically related questions called a Survey Tree, defining the associations between the questions (think: mind map layout). They Can then use Triggers to define Viewer entry points into the survey. In this way, Viewers are presented with questions that are thematically linked to Keywords/Phrases they are viewing and Question content. The presenting of subsequent Questions may be related to asking follow-up questions from the Survey Tree, rather than only from defined Triggers. Other actions may include: emailing certain content, contact info, or data to named contacts; presenting Client-defined HTML content (which may be linked to external systems; e.g. generating discount coupon codes from Client systems); calling other third-party client-side applications and services (e.g. use semantic knowledge capture to call existing survey software, but to targeted Viewers); etc.

Accounting—The accounting module will take care of Client Accounting and financial reporting.

Billing—The Billing module will take care of Client billing, invoicing, and payment processing.

Back-Office Administration—The Back-Office Administration sub-system is comprised of: Client Account Management, Marketing, Sales, Mass Email marketing System, and Financial & Customer Reporting.

End User Knowledge Portal Server—This system would only be available to Clients who use semantic knowledge capture in a closed system. The aim of the End user Knowledge Portal is to allow system participants (End Users) to analyze, organize, search, and share business knowledge.

Knowledge Sharing Portal Web Site—In a closed system, the goal of using semantic knowledge capture technology is to harvest, nurture, and share the collective wisdom of all of its employees. This wisdom is sometimes referred to as “institutional memory” or the “deep smarts” of the organization. The subject matter of the personal knowledge and intuition the Client hopes to extract generally relates to individual interpretation of policies and procedures; whose knowledge of which tends to be related to the Role and/or Function of the individual within the organization. The closed system implementation, therefore, will have a number of built-in campaigns for the collection of Human Resource related questions in order to populate a base user profile. Knowledge Blog—The Knowledge Blog (KLOG) is where the collection of a User's responses to questions are aggregated.

Organization Chart Explorer—The Organization Chart Explorer allows End User's of a defined Role and/or Function to view the collected answers of their colleagues. Users of like Role may view a curated portion of their colleagues' KLOGs.

Knowledge Quotient—The Knowledge Quotient sub-system is a means of ranking users based on both their implied knowledge of a subject (by virtue of the number of times they have view Keywords over time) and by their confirmed knowledge (as voted on by other End Users). A User's Knowledge Quotient is a measure of their effectiveness as a Subject Matter Expert.

Knowledge Experts (Subject Matter Experts)—This is an area of the Knowledge Sharing Portal Web Site where End Users may search for people who are knowledgeable about specific topics. The subjects of the Knowledge Expert's knowledge are created by one of the following processes: a) Clients define subjects within web site; b) system-generated (from an individual's Knowledge Quotient); or c) End User's nominate and vote on individuals. A list of subjects and associated Subject Matter Experts (SME) is available and searchable. End User's may then contact the SME to ask questions or view a portion of their KLOG.

Frequently Asked Questions—The Frequently Asked Questions (FAQs) module is an area of the End Knowledge Sharing Portal Web Site where User's may post Questions to be answered, and also view the library of available responses. Responses which are both “frequent” accessed and also simple and direct are considered appropriate.

Knowledge Base—The Knowledge Base (KB) module is an area of the End User Knowledge Portal web site where User's may post Questions to be answered, and also view the library of available responses. KB articles differ from FAQs in that their responses may be more details (perhaps even involving instruction).

Forums—The Forums module of the End User Knowledge Portal web site is an online discussion site where people can hold conversations in the form of posted messages. The forums have a hierarchical or treelike structure: a forum can contain a number of sub-forums, each of Which may have several topics. Within a forum's topic, each new discussion started is called a thread, and can be replied to by as many people as wish to. Any response within a discussion thread may be nominated for inclusion as an FAQ or a KB article.

Communities of Practice—The Communities of Practice (CoP) module of the Knowledge Sharing Portal Web Site is an area where End Users can create a child portal web site for people who share an interest, a craft, a rule, a function, and/or a profession. The CoP child portals will feature a sub-set of the Knowledge Sharing Portal Web Site's core functionality; in other words, there will be a FAQs, KB, Forums, KLOG access, message board, and live messaging all focused on the theme of the CoP.

Report Library—Clients will be able to run ad hoc queries and pre-defined reports on their collected analytics, Viewer responses, and portal content.

Analytics API—The Analytics API will be offered in the same fashion as the Production Server's API.

Web Services—The End user Knowledge Portal Server will feature Web Services to allow integration, communications, and the sharing of information with external Apps, programs, systems, and web sites.

Various illustrative examples of how the present system and method may be used will now be described.

First Use Case: A student reading a research paper online

1) The User reads the first “screen”—what is currently visible in the viewport when the web page loads.
The User sees the web page title.
The User sees the content title(s).
The user sees the first viewable portion of the page.
The User sees new instances of Find Words.
User spends x seconds reading the page.

2) The User scrolls down to read the next section (n)
Usually a small portion of the previous “screen” is visible for continuity
The User may see additional content sub-title(s).
The user sees the second viewable portion of the page.
The User sees new instances of Find Words.
User spends x (+/−20%) seconds reading the page. (i.e. mean reading time per screen volume is approximately the same.)

3) The User scrolls n+1
Usually a small portion of the previous “screen” is visible for continuity
The User may see additional content sub-title(s).
The User sees new instances of Find Words.
User spends x (+/−20%) seconds reading the page. (i.e. mean reading time per screen volume is approximately the same.)

4) The User scrolls up two sections very quickly
The User may see previous content sub-title(s).
The User may see previous instances of Find Words.
The user sees the n-2 viewable portion of the page.

5) The User scrolls n+3
Usually a small portion of the previous “screen” is visible for continuity
The User may see additional content sub-title(s).
The User sees new instances of Find Words.
User spends x (+/−20%) seconds reading the page. (i.e., mean reading time per screen volume is approximately the same.)

Inference: The longer one takes to read a screen, particularly if they are inching their way through a long page in a consistent manner, only to then jump back a bit, and then go back and continue; one might suppose that the user jumped back up to reread a difficult concept. The second viewing of the Find Words, along with the analysis of the behaviour that got them there, the system would calculate a greater weight to the tracked words due to their implied importance.

First Marketing Tool Use Case

As an illustrative example, suppose a leading electronics manufacturer is launching a new line of LED televisions to the Canadian market. The manufacturer decides to work with one of their leading retailers to launch the products. Their retailer, which has a strong web presence, decides to use semantic knowledge capture to increase the lead conversion rates from their website.

The retailer's first step is to create a Campaign. Their marketing department follows a very simple workflow that include creating the Concepts, Rules, and Actions that will collectively make up the Campaign. Their first step is to create a list of Concepts, such as names of the devices, company, model numbers, and other descriptive text that are collectively known as the Keywords. Next, they create the Rules that include parameters such as frequency, location, and the viewing of keywords in a particular order that trigger selected Actions—which are also defined. All of this workflow is completed online via their Client Dashboard, which then provides the tracking code for their Campaigns.

Tracking code which includes their Client ID is then copied and pasted into the appropriate web pages of,their website. From this moment, their account is ready to start collecting Viewer data and executing Campaigns.

A prospective customer (Viewer) who is interested in LED televisions goes directly to the retailer's website to conduct some basic product research. As soon that happens, a browser cookie is either created—or refreshes an existing cookie that had previously been created—in the Viewer's browser in order to uniquely identify the Viewer. Next, the tracking code starts to collect and communicate properties of the Viewer's system, device (computer type, monitor size, IP address, etc. . . . ), and browser window back to the semantic knowledge capture server, As the Viewer scrolls through the content in his browser Viewport, semantic knowledge capture collects continuously collects data relating to the volume of instances of Keywords that come into view. This data is transmitted to the server for post-event processing on a continuous basis to see if the User's scrolling behaviour has met the requirements of a Campaign Rule.

In this case, the Viewer decides to go to the retailer's website and after conducting some initial research about the features and benefits of LED televisions, leaves the website. Such research could include viewing product description pages, product review pages, help guides, etc.

Several days later, the Viewer decides to go back to the retailer's website to conduct further research. Once the Viewer hits any page on the web page with the tracking code, semantic knowledge capture again collects data on that particular Viewer. Semantic knowledge capture recognizes that this is not the first time that they have visited this particular page and as a result—based on the predetermined Rules, it triggers an Action. In this case, a simple question to the Viewer is posed, such as, “Would you like to see a copy of the whitepapers on LED Televisions?” If the Viewer answers yes, then a link to the whitepapers is presented to the Viewer who can choose to download it for their review. If the Viewer answers no, then semantic knowledge capture poses the next question in the logic tree, which in this case is, “Would you like to find out any further information about LED Televisions or have any questions that we can answer for you?” In this scenario, the Viewer declines.

Suppose a week goes by and the same Viewer goes back to the website to again review the information, starting out at the same page and so semantic knowledge capture is re-activated. Again, Rules trigger appropriate Actions and in this case, semantic knowledge capture asks the Viewer, “Are you interested in reading any of the product reviews that have been posted in the last seven days?” in which the Viewer may accept and start to review. Once completed, the Viewer leaves the site logs back on later that same day and starts reviewing information that is related to the prices of LED Televisions. Again, semantic knowledge capture goes to work and starts to interact with the Viewer. Since the Viewer has had experience with the website's interactivity, and has seen that it is not asking for any personal information but instead is offering assistance, the Viewer continues to interact with the website. It may ask questions about what brands they have procured in the past, what brands they are interested in—questions that are in the interest of the View in order to keep them engaged.

Finally, semantic knowledge capture offers the Viewer a time-restricted coupon that gives them a discount if they purchase the leading electronic manufacturer's brand LED television in the next 24 hours which the Viewer can printout or download onto one of their personal devices. The Viewer downloads the coupon, takes it to the local retailer, and proceeds to purchase the television. The clerk at retailer enters in the coupon code which is transmitted to the database and closes the loop on the tile for that particular Campaign with that specific Viewer.

Second Marketing Tool Use Case

Company wants to reduce the time and cost per sale by identifying Users or individual Consumers seeking a specific device or type of device.

Company creates a campaign (perhaps using a campaign design utility that is part of a web application), using specific keywords that specifically target the brand or device that they want to promote. They can make use of the density, frequency and timing of keyword views or geographic location or page navigation sequence in order to open a ‘one-time, personal incentive’ in order to close the deal. The company may want their offers to be tailored to more specific demographic and more granular criteria than what search engine based adwords etc. are able to provide.

The consumer visits the website of the Company and conducts activities showing intent to purchase such as: researching information, product descriptions, read product reviews and consumer feedback, conduct price comparisons, adding item to cart—but then abandoning purchase, etc.

Once the users' action matches a rule in the cascading logic tree, an action is called; such as providing additional information, offering live help, and ultimately—offering a onetime incentive in exchange for immediate action.

Enterprise e Capture) Use Case

A corporate IS department wants to conduct a system readiness study about Insurance Claims Management System. They want the survey to collect information from anyone that would ‘touch’ the system; including but not limited to: business users, data entry personnel, system administrators, etc.

IS creates a campaign asking questions such as: 1) do you call the help desk (yes/no) and a related question 2) name the person that you know that has the most knowledge and/or provides the best support.

These two questions have the ability to provide information as to how many/percentage of people that calls upon support, as well as identifying the key personnel that provide the best support. This information then gets fed into the company's Business Continuity Plan in order to provide better risk management for the company.

A Heuristic Engine (HE) can be employed to analyze the results, recognize the appropriate personnel and then communicate that information to Corporate IS in a variety of ways such as emailing the results to appropriate stakeholders (Corp IS and HR) as well as making an entry in a ‘knowledge profile’ (we call them Knowledge Logs or KLOGs for short).

This information becomes searchable to the appropriate people in the organization based upon whatever rules the company wants to employ (i.e. hierarchical).

The computer system and computer implemented method of the present invention provides first-party real time data collection and audience segmentation.

The present invention, in one aspect, enables development of consumer segments that are not strictly based on content verticals. This will improve competitiveness and enable placement of advertising outside of established content verticals, yet providing effective targeting.

The present invention also enables improved targeting through development of improved consumer insights and generation of more detailed and timely profile information regarding particular users.

The present system and method may be practiced in various embodiments. A suitably configured computer device, and associated communications networks, devices, software and firmware may provide a platform for enabling one or more embodiments as described above. By way of example, FIG. 5 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable a computer device to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

It should be understood that further enhancements to the disclosed system, method and computer program are envisioned.

1. A computer-implemented method for determining the interest or intent of an internet user, characterized in that the method comprises:
(a) initializing a semantic knowledge capture session for the user, using one or more computer processors;
(b) conducting a browser viewport analysis to identify one or more interactions between the user and one or more tagged information objects in one or more internet content items, where the tagged information objects are related to one or more topics; and
(c) analyzing the one or more interactions, using an analyzer, in order to measure the interest or intent of the user in relation to the one or more topics.

2. The method of claim 1, comprising the further step of using a dashboard to establish the one or more topics, and a list of associated find words that are related to the one or more topics.

3. The method of claim 2, comprising tagging the internet content using the find words, and using the viewport analysis to detect the interaction of the user with such find words in the internet content, and log such interactions in an array, and analyze the contents of the array so as to determine real time or near real time interest of the internet user in the one or more topics.

4. The method of claim 3, wherein the analysis of the contents of the array enables determination of real time or near real time interest based on a single frame of internet content.

5. The method of claim 3, comprising the further step of linking the user with a particular segment based on the determination of real time or near real time interest.

6. The method of claim 3, wherein the interactions consist of one or more of the following:
(a) viewing;
(b) selecting,
(c) clicking hyperlinks; or
(d) mouseing over.

7. The method of claim 6, comprising the further step of analyzing the interactions based on the frequency, recency, and volume of find words with which the interactions occurred.

8. The method of claim 1, wherein data is captured regarding interest or intent based on interactions of the user with a current internet frame.

9. The method of claim 5, comprising the further step of targeting the user with content based on the user's membership in the segment.

10. The method of claim 1, comprising the further step of creating or linking to a campaign manager, the campaign manager being configured for designing one or more campaigns, including one or more interest or intent profiles that are configured to trigger actions in the campaign.

11. The method of claim 1, comprising the further step of calculating an interest or intent score for the user based on the interactions, and optionally further based on the one or more interest or intent profiles.

12. A computer system for determining the interest or intent of one or more internet users comprising;
(a) a web server configured to make accessible to users internet content such as web pages, the web server including or being inked to a plug-in, the plug-in being operable to tag internet content based on one or more topics, and associated find words;
(b) one or more client computers, each client computer including or being linked to a data collection component, the data collection component including a viewport utility, the viewport utility being operable to detect and log the interactions of the user with the find words.

13. The computer system of claim 12, wherein the computer system further comprises a central server, the central server including or being linked to an analytics engine, wherein the data collection component logs the interactions and transfers information about the interactions to the central server, and the central server utilizes the analytics engine to extract semantic knowledge from the interactions on a real time or near real time basis.

14. The computer system of claim 12, wherein the computer system includes or links to a dashboard to establish the one or more topics, and a list of associated find words that are related to the one or more topics.

15. The computer system of claim 14, wherein the plug-in tags the internet content using the find words, and the viewport utility detects the interaction of the user with the find words, and the system analyzes the interactions so as determine real time or near real time interest of the internet user in the one or more topics.

16. The computer system of claim 15, wherein the interactions consist of one or more of the following:
(a) viewing;
(b) selecting;
(c) clicking hyperlinks; or
(d) mouseing over

17. The computer system of claim 12, wherein the analyzer is configured to analyze the interactions based on the frequency, recency, and volume of find words with which the interactions occurred.

18. The computer system of claim 12, further comprising or being linked to a campaign manager that enables administrative users to design or launch one or more campaigns, each campaign including one or more interest or intent profiles that are configured to trigger actions in the campaign.

19. The computer system of claim 12, wherein the analytics engine is operable to calculate an interest or intent score for the user based on the interactions, and optionally further based on the one or more interest or intent profiles.
